(19) United States
(12) Patent Application Publication
(10) Pub. No.: US 2010/0154301 A1
(43) Pub. Date: Jun. 24, 2010

(54) VEGETATION BOX AND GARDENING METHOD USING THE SAME

(76) Inventor: Woong Ho Song, Suwon-City Kyunggi-do (KR)

Correspondence Address: IPLA P.A., 3550 WILSHIRE BLVD., 17TH FLOOR, LOS ANGELES, CA, 90010, US

(21) Appl. No.: 12/279,305

(22) PCT Filed: Feb. 14, 2007
(86) PCT No.: PCT/KR2007/000793

§ 371 Date: Aug. 13, 2008

(30) Foreign Application Priority Data
Feb. 15, 2006 (KR) 10-2006-0014501

(51) Int. Cl. A01G 9/02

(52) U.S. Cl. 47/66.7; 47/65.5

(57) ABSTRACT

Provided is a vegetation box which enables oxygen to be smoothly supplied for roots of plants so that the plants to grow well even through the side portions of the vegetation box, and a gardening method using a number of vegetation boxes which are arranged to achieve a landscape architecture in a desired form. The vegetation box includes a lowermost module having a baseplate, at least one intermediate module, and an uppermost module. The lowermost module, the at least one intermediate module and the uppermost module are assembled with one another to be maintained at certain intervals to thereby form an inner space containing culture soil, and inclined surfaces are formed toward the lower portion of the inner space along circumferential edges of portions.

### TECHNICAL FIELD

The present invention relates to a vegetation box and a gardening method using the same, and more particularly, to a vegetation box which enables oxygen to be smoothly supplied for roots of plants so that the plants to grow well even through the side portions of the vegetation box, and a gardening method using a number of vegetation boxes which are arranged to achieve a landscape architecture in a desired form.

### BACKGROUND ART

Roots of plants have an important breath function in addition to absorption of water and nutritive substances for growth.

To maximize a respiratory function of these roots, a lot of techniques are suggested in composition of a vegetation box for growing plants.

Fox example, in the case of a vegetation box and a landscape architecture system disclosed in Korean patent registration No. 0479212, a number of spileholes are bored on the side of the vegetation box to help smooth breath of roots.

The disclosed landscape architecture system is achieved by employing a gardening method which includes the steps of connecting and combining a number of modular vegetation boxes on the sides of which a number of spileholes are bored.

When a number of vegetation boxes make up of a block form are connected and combined, it can be difficult to be ventilated at the junction surfaces between the vegetation boxes. In addition, in the case that the spileholes are exposed to the outside, it can be ventilated. However, soil used to vegetate plants can be leaked through the spileholes. Furthermore, in the case that water is supplied into the vegetation boxes, the water can be leaked through the spileholes formed on the sides of the vegetation boxes. Accordingly, such leakages of soil and water through the spileholes may cause contamination of the periphery of the gardening system formed of the vegetation boxes.

Meanwhile, in the case of an indoor garden disclosed in Korean patent registration No. 0377569, an air blowing fan is installed in a flowerpot to help smooth ventilation. Accordingly, air is forced to flow in the flowerpot by the air blowing fan from the outside. Thus, when the air blowing fan is installed at the lower portion of the flowerpot, an air stream is formed from the lower portion of the flowerpot to the upper portion thereof, to thereby help smooth ventilation.

However, since the conventional art vegetation box employs a planter containing water and an air blowing fan, a production cost increases, the whole size becomes large, a burden of electricity fare and safety in use due to use of electric power of a fan mechanism, a generation of a pollution gas by the air blowing fan, a breakdown rate of the air blowing fan, and noise caused by the air blowing fan bring back a lot of restrictions in practical use.

Meanwhile, soil is horizontally uniformly spread and piled up without making any slope with respect to the floors of ordinary flowerpots or vegetation boxes, and roots of plants are planted in the flowerpots or vegetation boxes. In this case, since short plants including low grasses or short flowers which are planted in flowerpots or vegetation boxes are hidden and thus are not visible to persons or children who are not tall, to accordingly lower an effect of admiration of plants.

### DISCLOSURE OF INVENTION

### Technical Problem

To solve the above problems, the present invention has the following objects.

First, an object is to provide a vegetation box and a gardening method preventing leakage of culture soil and water while helping external air smoothly supplied to roots of plants through the side of the vegetation box.

Second, another object is to provide a vegetation box and a gardening method which can support plants stably through the side of culture soil in the vegetation box to help the plants grow well.

Third, still another object is to provide a vegetation box and a gardening method which enables to embody a natural landscape architecture such as a hill of nature.

### Technical Solution

To accomplish the above object of the present invention, according to an aspect of the present invention, there is provided a vegetation box containing culture soil so that a plant may be vegetated, the vegetation box comprising:

a lowermost module having a baseplate;

at least one intermediate module; and

an uppermost module,

wherein the lowermost module, the at least one intermediate module and the uppermost module are assembled with one another to be maintained at certain intervals to thereby form an inner space containing culture soil, and

wherein inclined surfaces are formed toward the lower portion of the inner space along circumferential edges of portions where the lowermost module, the at least one intermediate module and the uppermost module mutually abut with one another, to thereby form an air path.

Preferably, the top portion of the lower inclined surface among the inclined surfaces opposing each other is located at a substantially same height as that of the lower portion of the upper inclined surface, or the former is located at a height higher than that of the latter.

Preferably, the upper edge of the uppermost module is formed slopely at a desired angle with respect to the lower edge thereof.

There is also provided a gardening method using vegetation boxes which adjoin mutually to make up a landscape architecture of a desired form, the gardening method comprising:

preparing a lowermost module, at least one intermediate module and an uppermost module;

assembling the lowermost module, the at least one intermediate module and the uppermost module with one another to be maintained at certain intervals to thereby form an inner space containing culture soil;

forming inclined surfaces toward the lower portion of the inner space along circumferential edges of portions where the lowermost module, the at least one intermediate module and the uppermost module mutually abut with one another, to thereby form an air path;

making the top portion of the lower inclined surface among the inclined surfaces opposing each other located at a substantially same height as that of the lower portion of the upper inclined surface, or the former is located at a height higher than that of the latter;

making the upper edge of the uppermost module formed slopely at a desired angle with respect to the lower edge thereof, so that the culture soil can be slopely piled up in the uppermost modules among the vegetation boxes; and

making the respective vegetation boxes adjoin one another to thereby form hills having the substantially same heights as those of plants planted in the respective vegetation boxes.

### Advantageous Effects

As described above, according to the features of the present invention, a vegetation box and a gardening method according to the present invention prevents leakage of culture soil and water while helping oxygen smoothly supplied to roots of plants through an air path formed at the side of the vegetation box, to thereby help the plants grow smoothly. Further, the vegetation box and the gardening method according to the present invention can support plants stably through an air path formed at the side of culture soil in the vegetation box to help the plants grow well. Still further, a plurality of vegetation boxes each having a different gradient of the upper edge of the uppermost module of the vegetation box and a different gradient of culture soil contained in the uppermost module thereof, are made to adjoin one another to thereby form a landscape architecture such as a natural hill.

### BRIEF DESCRIPTION OF THE DRAWINGS

The above and/or other objects and/or advantages of the present invention will become more apparent by describing the preferred embodiments thereof in detail with reference to the accompanying drawings in which:

FIG. 1 is a perspective view showing a vegetation box according to an embodiment of the present invention;

FIG. 2 is a disassembled perspective view of FIG. 1;

FIG. 3 is a plan view of FIG. 1;

FIG. 4 is a front view of FIG. 1;

FIG. 5 is a side view of FIG. 1;

FIG. 6 is a cross-section view of FIG. 1;

FIG. 7 is a cross-sectional view of another embodiment of FIG. 1;

FIG. 8 is a view showing a vegetation box containing culture soil and vegetating plants as in the vegetation box shown in FIG. 1;

FIG. 9 is a cross-sectional view of the essential parts in the vegetation box according to the present invention;

FIG. 10 is a cross-sectional view of the essential parts of a vegetation state through an air path formed in the vegetation box according to the present invention;

FIG. 11 is a perspective view illustrating a state where vegetation boxes are arranged and combined with one another to explain a gardening method of the present invention;

FIG. 12 is a plan view of FIGS. 11; and

FIG. 13 is a side view illustrating a state where plants are planted in vegetation boxes of FIG. 11.

### BEST MODE FOR CARRYING OUT THE INVENTION

Hereinbelow, a vegetation box and a gardening method using the same according to respective preferred embodiments of the present invention will be described with reference to the accompanying drawings. Like reference numerals denote like elements through the following embodiments.

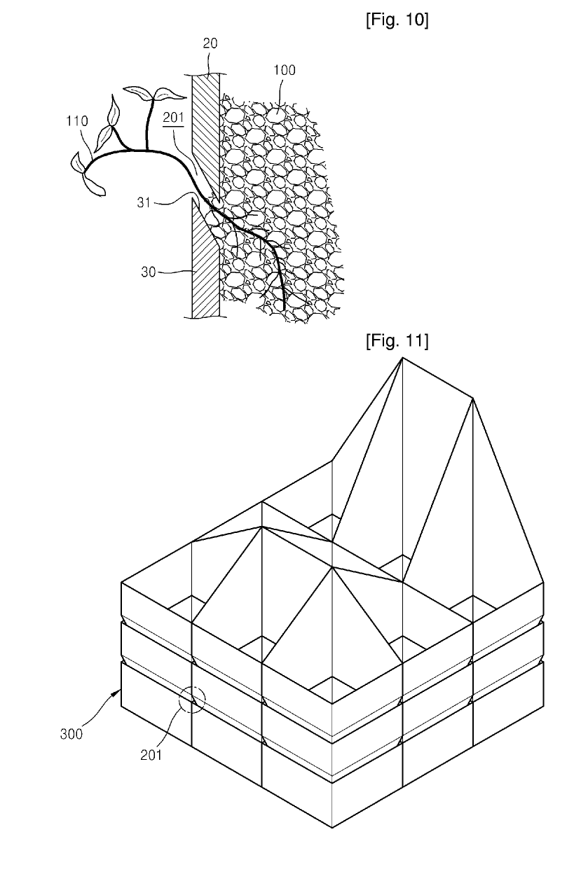

A vegetation box 300 according to an embodiment of the present invention contains culture soil 100 so that plants 110 can be vegetated therein, as shown in FIGS. 9 and 10.

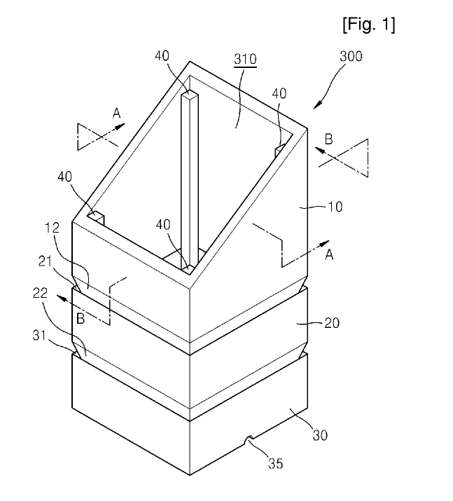

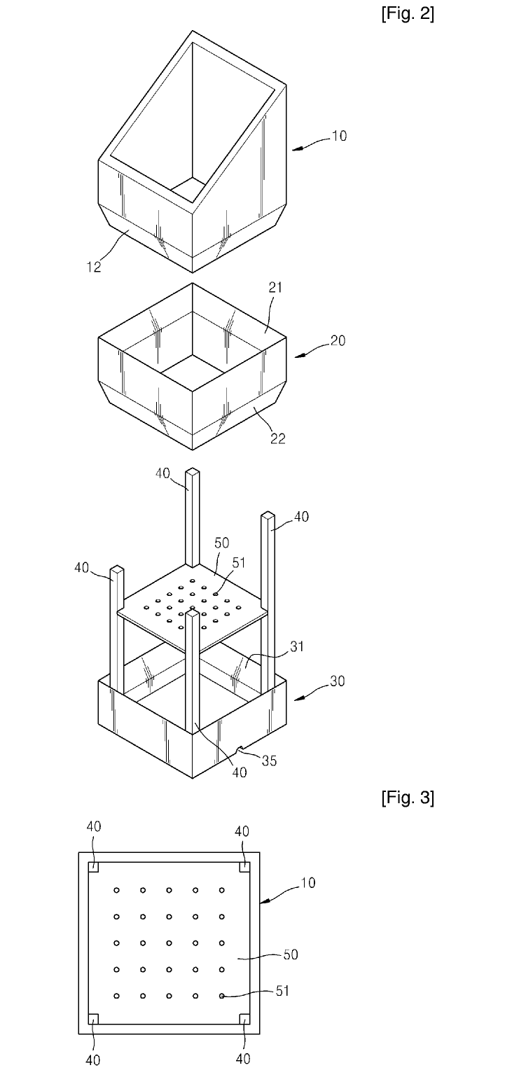

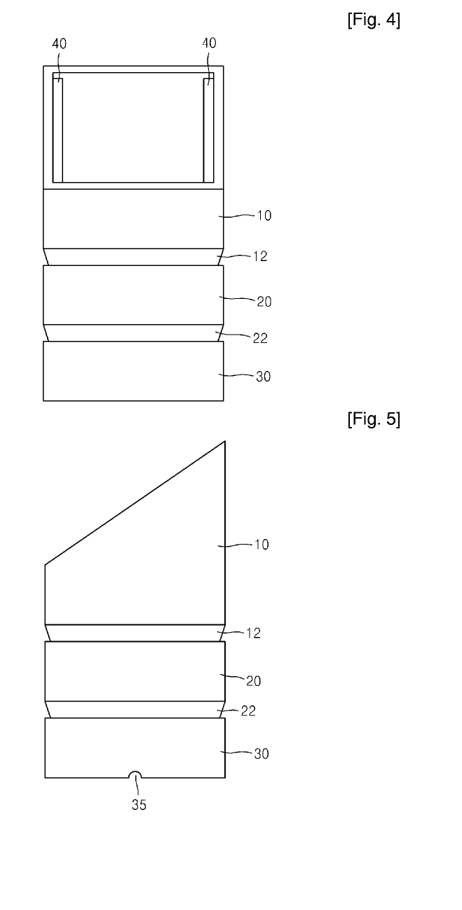

Referring to FIGS. 1 to 6, a vegetation box 300 forms an inner space 310 accommodating culture soil 100 which includes a lowermost module 30 having a baseplate on which a water exit groove 35 is formed, at least one intermediate module 20, and an uppermost module 10. Here, the lowermost module 30, the at least one intermediate module 20 and the uppermost module 10 are assembled with one another to be maintained by supports 40 at certain intervals to thereby form the inner space 310 containing culture soil.

The respective modules 10, 20 and 30 and supports 40 can be made of wooden materials or synthetic resin materials, and is adhered by nails or adhesives.

In addition the respective modules 10, 20 and 30 are formed into a circular ring shape or polygonal ring shape.

The respective modules 10, 20 and 30 according to the embodiments of the present invention are formed into a rectangular ring shape.

Inclined surfaces 12, 21, 22 and 31 are formed toward the lower portion of the inner space 310 along circumferential edges of portions where the lowermost module 30, the at least one intermediate module 20 and the uppermost module 10 mutually abut with one another, to thereby form an air path 201.

Here, the top portions of the lower inclined surfaces 21 and 31 among the inclined surfaces 12, 21, 22, and 31 opposing each other is located at a substantially same height as that of the lower portion of the upper inclined surfaces 12 and 22, or the former is located at a height higher than that of the latter (refer to a dotted line “A”).

In the drawings, a reference numeral 50 denotes a soil support plate and a reference numeral 51 denotes a water exit hole.

In this case, referring to FIG. 9, even if culture soil 100 is accommodated in the inner space 310, the culture soil 100 does not leak through the air path 201 to the outside of the vegetation box 300. In addition, even if water is supplied into the vegetation box 300, from the upper portion of the vegetation box 300 to the lower portion thereof, the water does not leak through the air path 201, but is naturally supplied into the lower portion of the vegetation box 300 and drained.

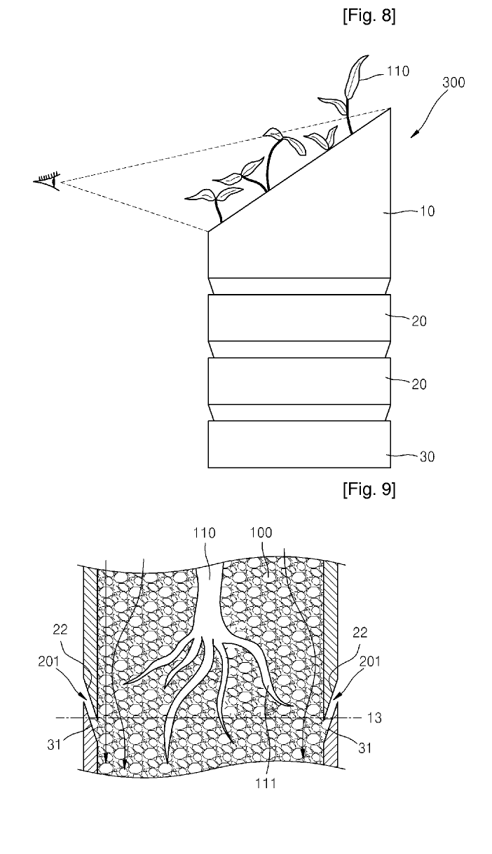

In addition, the upper edge of the uppermost module 10 is formed slopely at a desired angle with respect to the lower edge thereof. In this case, the upper surface of the accommodated culture soil 100 is formed slopely, for example, at an angle of 20 to 60 degrees. Thus, as shown in FIG. 8, the whole plants planted in the vegetation box 300 can be observed even at a horizontal position.

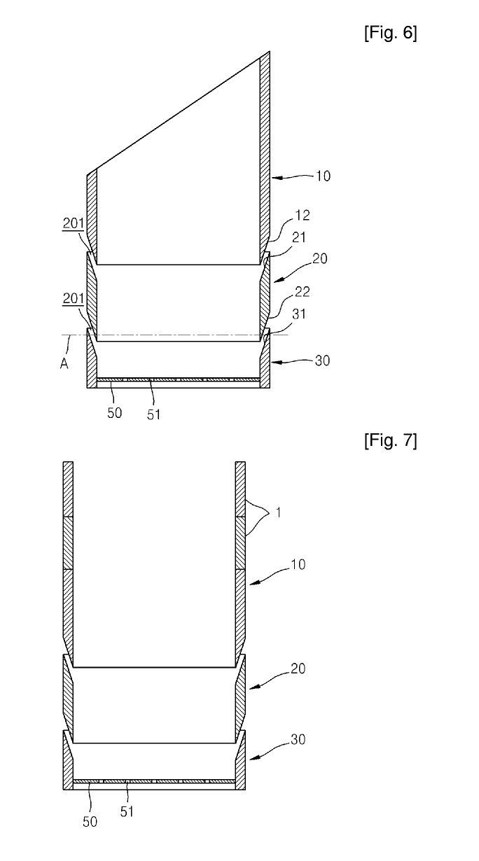

Meanwhile, as shown in FIG. 7, at least one control module 1 whose upper edge is horizontal is put on the uppermost module 10 to thus adjust the height of the vegetation box 300.

As shown in FIG. 9, in the case of the vegetation box 300 having the above-described structure, the external air supplied through the air path 201 can be smoothly supplied to roots 111 of a plant 110 through the culture soil 100. As shown in FIG. 10, the plant 110 can grow through the air path 201. In this case, since the plant 110 can be supported by the end of the inclined surface 31, the plant 110 can be more stably vegetated.

Furthermore, as shown in FIG. 8, since the uppermost module 10 of the vegetation box 300 is slantingly formed, and the culture soil 100 is slopely piled up, the whole plant 110 can be observed even at a horizontal position.

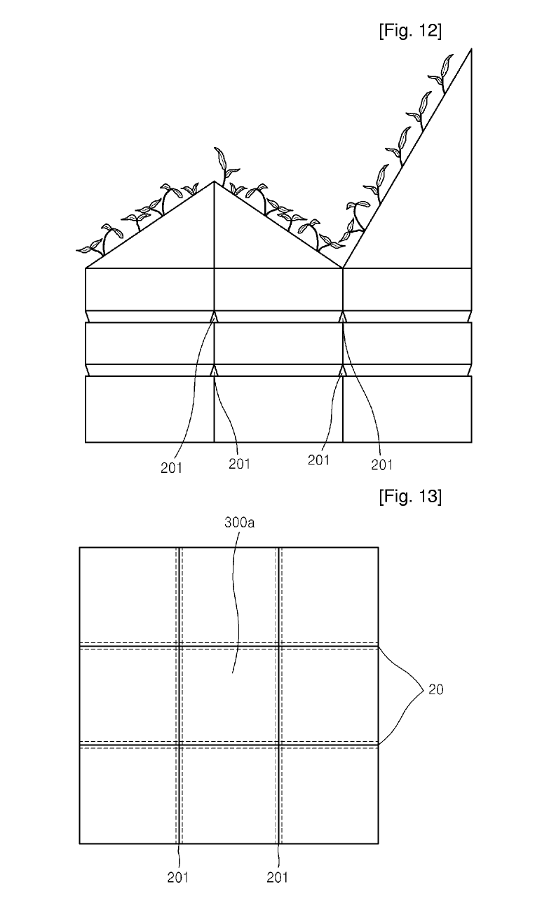

Meanwhile, referring to FIGS. 11 to 13 for explaining a gardening method according to the present invention, a desired number of vegetation boxes 300 according to the above-described embodiments of the present invention are made to adjoin one another in the form of a desired pattern. Here, the vegetation boxes 300 whose upper edge gradients in the upper modules 10 differ mutually are made to adjoin to thus make the heights of the plants planted in the vegetation boxes 300 differ mutually. Accordingly, natural hills can be formed.

Here, in the case of the mutually adjoining vegetation boxes 300, the air paths 201 formed by the inclined surfaces adjoin mutually. Accordingly, the external air can flow in smoothly up to the vegetation box 300a which is located in the inside which is surrounded by the other vegetation boxes 300. As a result, air can be supplied smoothly to the plant roots even in the inner vegetation box 300a.

As described above, the present invention prevents leakage of culture soil and water through a plurality of modules having inclined surfaces, while helping oxygen smoothly supplied to roots of plants through an air path formed at the side of the vegetation box.

Further, the present invention can make plants grow well through an air path formed at the side of culture soil in the vegetation box to help the plants grow well. In addition, the present invention can support the plants to the inclined surface of the air path, to thus enable stable vegetation.

Still further, a plurality of vegetation boxes each having a different gradient of the upper edge of the uppermost module of the vegetation box and a different gradient of culture soil contained in the uppermost module thereof, are made to adjoin one another to thereby achieve a landscape architecture such as a natural hill.

Yet further, even if a plurality of vegetation boxes are made to adjoin mutually, oxygen can be smoothly supplied to roots of plants through the sides of the vegetation boxes which are located in the inner portion of the vegetation boxes by the air paths each having an inclined surface.

### Mode for the Invention

As described above, the present invention has been described with respect to particularly preferred embodiments. However, the present invention is not limited to the above embodiments, and it is possible for one who has an ordinary skill in the art to make various modifications and variations, without departing off the spirit of the present invention. Thus, the protective scope of the present invention is not defined within the detailed description thereof but is defined by the claims to be described later and the technical spirit of the present invention.

### INDUSTRIAL APPLICABILITY

As described above, the present invention provides a vegetation box which enables oxygen to be smoothly supplied for roots of plants so that the plants to grow well even through the side portions of the vegetation box, and a gardening method using a number of vegetation boxes which are arranged to achieve a landscape architecture in a desired form.

1. A vegetation box containing culture soil so that a plant may be vegetated, the vegetation box comprising:
a lowermost module (30) having a baseplate;
at least one intermediate module (20); and
an uppermost module (10),
wherein the lowermost module (30), the at least one intermediate module (20) and the uppermost module (10) are assembled with one another to be maintained at certain intervals to thereby form an inner space containing culture soil, and
wherein inclined surfaces are formed toward the lower portion of the inner space along circumferential edges of portions where the lowermost module (30), the at least one intermediate module (20) and the uppermost module (10) mutually abut with one another, to thereby form an air path (201).

2. The vegetation box according to claim 1, wherein the upper edge of the uppermost module (10) is formed slopely at a desired angle with respect to the lower edge thereof.

3. The vegetation box according to claim 1, wherein the top portion of the lower inclined surface among the inclined surfaces opposing each other is located at a substantially same height as that of the lower portion of the upper inclined surface, or the former is located at a height higher than that of the latter.

4. A gardening method using vegetation boxes which adjoin mutually to make up a landscape architecture of a desired form, the gardening method comprising:
preparing a lowermost module (30), at least one intermediate module (20) and an uppermost module (10);
assembling the lowermost module (30), the at least one intermediate module (20) and the uppermost module (10) with one another to be maintained at certain intervals to thereby form an inner space containing culture soil;
forming inclined surfaces toward the lower portion of the inner space along circumferential edges of portions where the lowermost module (30), the at least one intermediate module (20) and the uppermost module (10) mutually abut with one another, to thereby form an air path (201);
making the top portion of the lower inclined surface among the inclined surfaces opposing each other located at a substantially same height as that of the lower portion of the upper inclined surface, or the former is located at a height higher than that of the latter;
making the upper edge of the uppermost module formed slopely at a desired angle with respect to the lower edge thereof, so that the culture soil can be slopely piled up in the uppermost modules among the vegetation boxes; and
making the respective vegetation boxes adjoin one another to thereby form hills having the substantially same heights as those of plants planted in the respective vegetation boxes.
